(19) United States
(12) Patent Application Publication
(10) Pub. No.: US 2022/0261517 A1
(43) Pub. Date: Aug. 18, 2022

(54) SIMULATION METHOD FOR ELECTROMAGNETIC MULTI-SCALE DIFFUSION

(71) Applicant: Jilin University, Changchun (CN)

(72) Inventors: Yanju JI, Changchun (CN); Xuejiao ZHAO, Changchun (CN); Yibing YU, Changchun (CN); Shipeng WANG, Changchun (CN); Jun LIN, Changchun (CN); Qiong WU, Changchun (CN); Dongsheng LI, Changchun (CN); Hui LUAN, Changchun (CN); Yuan WANG, Changchun (CN); Shanshan GUAN, Changchun (CN)

(21) Appl. No.: 17/739,216

(22) Filed: May 9, 2022

Related U.S. Application Data
(63) Continuation-in-part of application No. 17/190,445, filed on Mar. 3, 2021.

(30) Foreign Application Priority Data
Oct. 29, 2020 (CN) 202011177685.9
Oct. 29, 2020 (CN) 202011177721.1

(51) Int. Cl. G06F 30/20

(52) U.S. Cl. CPC G06F 30/20; G06F 2111/10

(57) ABSTRACT

Provided is a simulation method of distribution of electric field or magnetic field values for two-phase conducting media, including: 1) setting a simulated computation area, setting electric field or magnetic field distribution nodes in the simulated computation area, and setting an artificial current source at the origin of coordinates; 2) selecting a shape function, and setting shape function parameters, Gaussian integral parameters, and electromagnetic parameters; 3) loading a node and searching for nodes in the radius of the support domain, discretizing the definite integral by a 4-point Gaussian integral equation, then interpolating and summing to obtain the fractional derivative of the shape function, assigning the shape function result to the corresponding position of the large sparse matrix in the spatial fractional electric field diffusion equation.

### CROSS-REFERENCE TO RELAYED APPLICATIONS

This application is a continuation-in-part of U.S. patent application Ser. No. 17/190,445 filed on Mar. 3, 2021, now pending, and further claims foreign priority to Chinese Patent Application No. 202011177685.9 filed on Oct. 29, 2020, and to Chinese Patent Application No. 202011177721.1 filed on Oct. 29, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to three-dimensional simulation method of time-domain multi-scale electromagnetic diffusion by using a space-time fractional conductivity modeling for two-phase conducting media, especially for the high-precision three-dimensional numerical simulation of the induction and polarization effects caused by the complex geometric structure of the actual earth media.

In time domain transient electromagnetic methods, a long wire source or loop source is used to output time-varying current underground to excite the earth media to generate an induced electromagnetic field. By measuring electric or magnetic field signals, the electrical characteristics and the structure of the underground media are detected. As a non-uniform and strong dissipative medium, the earth's lithology and physical properties show high non-uniformity and non-linearity. Especially, resources such as concealed or disseminated polymetallic deposits, oil and gas reservoirs, composite oil and gas reservoirs, and geothermal energy are all composite multi-phase conducting media, so multi-scale measurement of complex physical features or parameters becomes especially important. Low-resistance and high-polarization anomalies are one of the important indicators for detection of sulfide-type, lead-zinc-silver and other polymetallic deposits in geophysical method, while high-resistance and high-polarization anomalies are important indicators for identification of oil and gas reservoirs. By the excitation of the alternating field, the induction and polarization effects in the multi-phase conducting media coexist and accompany each other. The induction response can appropriately distinguish formation lithology, and the polarization response can effectively identify favorable oil and gas reservoirs and metal mine anomalies.

At present, the research on the polarization effect mainly focuses on the numerical calculation of the electromagnetic response of complex polarization bodies in the three-dimensional Cole-Cole model and involves only the study of electromagnetic single-scale diffusion. However, there has been no relevant research on electromagnetic multi-scale diffusion. The Cole-Cole or GEMTIP model can characterize only the induction and polarization effects caused by the frequency dispersion characteristics of the media. For the oil and gas reservoirs and porous media of which the geometric structure would also cause the induction effect, the existing models can no longer accurately extract information about resistivity.

### SUMMARY

The disclosure relates to a three-dimensional simulation method of time-domain multi-scale electromagnetic diffusion by using a space-time fractional conductivity modeling of two-phase conducting media. A space fractional term is introduced into the conductivity model of the two-phase conducting media to establish a multi-scale space-time fractional conductivity model for accurately characterizing the induction and polarization effects of the media, in which the time fractional term characterizes the porous polarization effect of the media and the space fractional term characterizes the induction effect caused by the complex geometric structure of the media. The newly constructed conductivity model is introduced into an electromagnetic diffusion equation, and the time and space fractional differential terms are solved in the frequency domain using a combination of finite difference and meshless methods. Finally, the numerical simulation of the time domain multi-scale induction-polarization symbiosis effects of the electromagnetic field is completed by frequency-time conversion.

A simulation method of electromagnetic diffusion for two-phase conducting media comprises:

1) by means of a computer, setting a simulated computation area having a reference coordinate system based on the realistic detection area; setting nodes for obtaining the electric field or magnetic field distribution in the computation area based on the realistic detection spots; setting the middle point of an artificial current source at the origin of the reference coordinate system; and applying Dirichlet boundary conditions at the boundary of the computation area;

2) by means of the computer, constructing a multi-scale space-time fractional conductivity model using

$$σ ( ω ) = {{σ}_{0} ( i v )}^{α} ( 1 + {f}_{1} {M}_{1} [ 1 - \frac{1}{1 + {( i {ωτ}_{1} )}^{{C}_{1}}} ] + {f}_{2} {M}_{2} [ 1 - \frac{1}{1 + {( i {ωτ}_{2} )}^{{C}_{2}}} ] ) ; \qquad ( 1 )$$

wherein:

the conductivity model comprises a space fractional term, and a time fractional term for particles of a certain type in the media; wherein the space fractional term characterizes the induction effect caused by the complex geometric structure of the media, and the time fractional term for the particles of the certain type characterizes the polarization effect of the particles of the certain type;

σ(ω) is the conductivity in the frequency domain, i is the imaginary part, ω is the angular frequency, and σ₀ is the value of the DC conductivity;

(iv)^{α} represents the space fractional term, and is a space fractional operator having a fractional order α for the Fourier mapping, α is the fractal dimension of the anomaly, and v is the dimensionless geometric factor;

$$\frac{1}{1 + {( i {ωτ}_{1} )}^{{C}_{1}}}$$

represents the time fractional term for the type-1 particles, τ₁ is the time constant of the type-1 particles, and C₁ is the dispersion coefficient of the type-1 particles;

f₁ is the volume fraction of the type-1 particles, and M₁ is the rock material property tensor of the type-1 particles;

$$\frac{1}{1 + {( i {ωτ}_{2} )}^{{C}_{2}}}$$

represents the space fractional term for the type-2 particles, τ₂ is the time constant of the type-2 particles, and C₂ is the dispersion coefficient of the type-2 particles; and

f₂ is the volume fraction of the type-2 particles, M₂ is the rock material property tensor of the type-2 particles;

3) by means of the computer, setting the current amplitude and the frequency for the emitting current of the current source, parameters for the conductivity model, the ground conductivity, the air conductivity, and the magnetic permeability; selecting a shape function in the computation area by a meshless method, and setting parameters for the shape function, a radius of a support domain, Gaussian integral parameters;

4) by means of the computer, obtaining a spatial fractional electric-field diffusion equation by substituting the expression (1) for the conductivity model into the diffusion equation of the electric field; and processing the spatial fractional electric-field diffusion equation to form a linear equation system for all nodes;

5) by means of the computer, solving the linear equation system to obtain an electric field value at each node and obtain the magnetic field value of a corresponding node by a curl equation for the electric field; whereby obtaining the distribution of electric field values and magnetic field values at the frequency; and

6) by means of the computer, obtaining the distribution of electric field and magnetic field values at different frequencies by changing the frequency of the emitting current and repeating 4) and 5).

In a class of this embodiment, the method comprises comparing the distribution of electric field values and magnetic field values at different frequencies obtained in 6) with the corresponding distribution of electric field values and magnetic field values obtained by realistic field detection, so as to optimize the parameters for the conductivity model.

In a class of this embodiment, 4) comprises:
41) transforming, by fractional operator transformation, the space fractional operator in the multi-scale space-time fractional conductivity model into a Laplacian operator of the electric field to obtain a fractional Laplacian operator, to obtain the spatial fractional electric field diffusion equation;
42) expanding, by the Caputo fractional definition, the spatial fractional electric field diffusion equation into a fractional differential form;
43) transforming, by a radial point interpolation meshless method, the second-order partial differential operation of the electric field into the second-order partial differential interpolation of the shape function, to complete the discretization of the differential term in the Caputo fractional order; and
44) transforming, by a Gaussian numerical integration method, the integral operation into Gaussian numerical integration accumulation, to complete the discretization of the integral term in the Caputo fractional order.

In a class of this embodiment, in 41), the expression (1) for the multi-scale space-time fractional conductivity model is substituted into the diffusion equation of the frequency domain electric field of the two-phase conducting media:

$${∇}^{2} E - {{σ}_{0} ( i ν )}^{α} ( 1 + {f}_{1} {M}_{1} [ 1 - \frac{1}{1 + {( i {ωτ}_{1} )}^{{C}_{1}}} ] + {f}_{2} {M}_{2} [ 1 - \frac{1}{1 + {( i {ωτ}_{2} )}^{{C}_{2}}} ] ) ( i ωμ E ) = 0 ; \qquad ( 2 )$$

wherein ∇² is the Laplacian operator, E is the electric field, and μ is the magnetic permeability;
both ends of equation (2) are multiplied by (iv)-^{α} to obtain the spatial fractional electric-field diffusion equation:

$${( {∇}_{v}^{2} )}^{s} E - {σ}_{0} ( 1 + {f}_{1} {M}_{1} [ 1 - \frac{1}{1 + {( i {ωτ}_{1} )}^{{C}_{1}}} ] + {f}_{2} {M}_{2} [ 1 - \frac{1}{1 + {( i {ωτ}_{2} )}^{{C}_{2}}} ] ) ( i ωμ E ) = 0 ; \qquad ( 3 )$$

wherein

$$s = 1 - \frac{α}{2} , {( {∇}_{v}^{2} )}^{s}$$

is the fractional Laplacian operator in the dimensionless coordinates v; and the three-dimensional expression of the fractional Laplacian operator is:

$${( {∇}_{v}^{2} )}^{s} E = \frac{{\partial }^{2 s} E}{\partial {x}^{2 s}} + \frac{{\partial }^{2 s} E}{\partial {y}^{2 s}} + \frac{{\partial }^{2 s} E}{\partial {z}^{2 s}} ; \qquad ( 4 )$$

wherein E represents the electric field, and x, y, and z each represent the deflection of the electric field in a direction.

In a class of this embodiment, in 42), by the Caputo fractional definition expansion, the space fractional differential term in the equation (4) is discretized and approximated:

$$\frac{{\partial }^{2 s} E}{\partial {u}^{2 s}} = \frac{1}{Γ ( 2 - 2 s )} {\int }_{a}^{u} \frac{{E}^{( 2 )} ( τ )}{{( u - τ )}^{2 s - 1}} d τ + \frac{1}{Γ ( 2 - 2 s )} {\int }_{u}^{b} \frac{{E}^{( 2 )} ( τ )}{{( u - τ )}^{2 s - 1}} d τ \qquad ( 5 )$$

wherein u=x, y or z, Γ is the gamma function, a is the lower limit of integration in the μ direction, b is the upper limit of integration in the u direction, and τ is the integral variable.

In a class of this embodiment, in 43) transforming, by a radial basis function meshless method, the second-order partial differential operation of the electric field into the second-order partial differential interpolation of the shape function to complete the discretization of the differential term in the Caputo fractional order in Equation (5):

$$\frac{{\partial }^{2 s} E}{\partial {u}^{2 s}} = {\sum }_{i = 1}^{n} [ \frac{1}{Γ ( 2 - 2 s )} {\int }_{a}^{u} \frac{{∅}_{ui}^{( 2 )} ( τ )}{{( u - τ )}^{2 s - 1}} d τ + \frac{1}{Γ ( 2 - 2 s )} {\int }_{u}^{b} \frac{{∅}_{ui}^{( 2 )} ( τ )}{{( τ - u )}^{2 s - 1}} d τ ] {E}_{i} \qquad ( 6 )$$

wherein Γ is the gamma function, Eᵢ is a number of interpolation nodes near E, ϕᵤᵢ is the corresponding interpolation shape function, ϕᵤᵢ⁽²⁾ is the second-order partial derivative of the interpolation shape function with respect to u.

In a class of this embodiment, in 44), transforming, by a Gaussian numerical integration method, the integral operation into Gaussian numerical integration accumulation to complete the discretization of the integral term in the Caputo fractional order:

first, transforming an integration interval into unit sub-units by coordinate transformation, wherein, if

$$τ = \frac{u - a}{2} η + \frac{u + a}{2} ,$$

then:

$$\frac{u - a}{{2}^{2 - 2 s}} {\int }_{- 1}^{1} \frac{{∅}_{i}^{( 2 )} ( \frac{u - a}{2} η + \frac{u + a}{2} )}{{( u - u η + a η - a )}^{2 s - 1}} d η \qquad ( 7 )$$

second discretizing the integral term by the Gaussian numerical integration method:

$$\frac{u - a}{{2}^{2 - 2 s}} {\sum }_{k = 1}^{n} {A}_{k} \frac{{ϕ}_{i}^{( 2 )} ( \frac{u - a}{2} {η}_{k} + \frac{u + a}{2} )}{{( u - u {η}_{k} + a {η}_{k} - a )}^{2 s - 1}} \qquad ( 8 )$$

wherein ηₖ is the Gaussian integration point and Aₖ is the weight coefficient.

The disclosure also provides a device for geological exploration, the device comprising:

a computer, configured to simulate the distribution of electric and magnetic field values in different geological structures, and to set different transmitting parameters and receiving distances, and different nodes and different frequencies;

a transient electromagnetic (TEM) detection system comprising a transmitting system and a receiving system; the transmitting system being configured, according to different geological structure characteristics and detection targets, to set the transmitting parameters and the receiving distance, based on the transmitting parameters and the receiving distance corresponding to the geological electric field value and magnetic field value under different frequencies simulated by the computer, and to transmit the current according to the transmitting parameters, and the receiving system being configured to synchronously collect the geological signal excited by the transmitting system.

In another aspect, the disclosure provides a method for setting of parameters of the device for geological exploration, the method comprising:

molding a geological structure, and simulating the distribution of electric and magnetic field values under different transmitting parameters and receiving distance, different nodes and different frequencies; and

according to the characteristics of geological structure and target to be detected, determining the transmitting parameters and receiving distance corresponding to the electric field value and magnetic field value of geology under different frequencies, and setting the transmitting parameters and receiving distance of TEM detection system.

The following advantages of the disclosure are associated with the method of the disclosure: a multi-scale space-time fractional conductivity model for characterizing complex rock structures is proposed, which can accurately describe the induction-polarization symbiosis effects of complex geometric structures. The fractional Laplacian operator is simplified by the Caputo fractional definition, to overcome the difficulty in solving the space fractional differential. Furthermore, the differential and integral terms are discretized respectively by the radial point interpolation meshless method and the Gaussian numerical integration method, which avoids too complex process, and provides a theoretical basis for the electromagnetic wave propagation mechanisms of complex geological structures.

### BRIEF DESCRIPTION OF THE DRAWINGS

FIG. 1 is a flowchart of a space-time fractional conductivity modeling and simulation method of two-phase conducting media;

FIG. 2 is a view comparing the numerical solution by the meshless method and the Mittag-Leffler function as the analytical solution, by taking a one-dimensional diffusion equation as an example;

FIG. 3 shows the influence of the fractal dimension on the received induced electromotive force; and

FIG. 4 shows the influence of the polarizability on the received induced electromotive force.

### DETAILED DESCRIPTION

To further illustrate the disclosure, embodiments detailing a space-time fractional conductivity modeling and simulation method of two-phase conducting media are described below. It should be noted that the following embodiments are intended to describe and not limit disclosure.

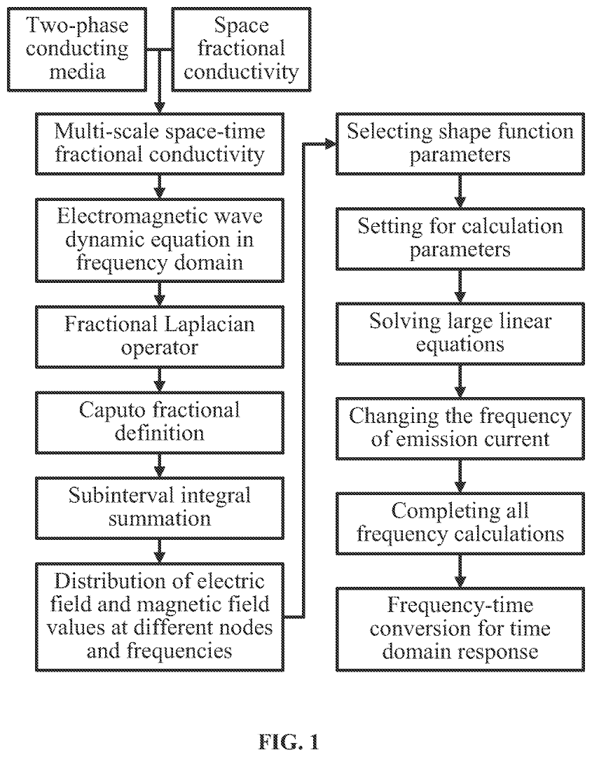

With reference to FIG. 1, a simulation method of electromagnetic diffusion for two-phase conducting media comprises:

1) by means of a computer, setting a simulated computation area having a reference coordinate system based on the realistic detection area, setting nodes for obtaining the electric field or magnetic field distribution in the computation area based on the realistic detection spots, and setting the middle point of an artificial current source as the origin of the reference coordinate system; and applying Dirichlet boundary conditions at the boundary of the computation area; wherein the artificial current source corresponds to the transmitter of an electric source electromagnetic transmitting system which is a long wire; the length and the position of the current source are determined according to the geological conditions in the realistic detection area; the emitting current of the artificial current source has a waveform in any shape, preferably, a sinusoidal waveform;

2) by means of the computer, constructing a multi-scale space-time fractional conductivity model using

$$σ ( ω ) = {{σ}_{0} ( i v )}^{α} ( 1 + {f}_{1} {M}_{1} [ 1 - \frac{1}{1 + {( i ω {τ}_{1} )}^{{C}_{1}}} ] + {f}_{2} {M}_{2} [ 1 - \frac{1}{1 + {( i ω {τ}_{2} )}^{{C}_{2}}} ] ) ; \qquad ( 1 )$$

wherein:

the conductivity model comprises a space fractional term, and a time fractional term for particles of a certain type in the media; wherein the space fractional term characterizes the induction effect caused by the complex geometric structure of the media, and the time fractional term for the particles of the certain type characterizes the polarization effect of the particles of the certain type;

σ(ω) is the conductivity in the frequency domain, i is the imaginary part, ω is the angular frequency, and σ₀ is the value of the DC conductivity;

(iv)^{α} represents the space fractional term, and is a space fractional operator having a fractional order α for the Fourier mapping, α is the fractal dimension of the anomaly, and v is the dimensionless geometric factor;

$$\frac{1}{1 + {( i ω {τ}_{1} )}^{{C}_{1}}}$$

represents the time fractional term for the type-1 particles, τ₁ is the time constant of the type-1 particles, and C₁ is the dispersion coefficient of the type-1 particles;

f₁ is the volume fraction of the type-1 particles, and M₁ is the rock material property tensor of the type-1 particles;

$$\frac{1}{1 + {( i ω {τ}_{2} )}^{{C}_{2}}}$$

represents the space fractional term for the type-2 particles, τ₂ is the time constant of the type-2 particles, and C₂ is the dispersion coefficient of the type-2 particles; and

f₂ is the volume fraction of the type-2 particles, M₂ is the rock material property tensor of the type-2 particles;

3) by means of the computer, setting the current amplitude and the frequency for the emitting current of the current source, parameters for the conductivity model (including the value of the DC conductivity, the volume fraction of the particles, the time constant of the particles, the dispersion coefficient of the particles, the rock material property tensor of the particles, and the fractal dimension of the anomaly), the ground conductivity, the air conductivity, and the magnetic permeability; selecting a shape function in the entire computation area by a meshless method, and setting parameters for the shape function, a radius of a support domain, and Gaussian integral parameters;

4) by means of the computer, obtaining a spatial fractional electric-field diffusion equation by substituting the conductivity model into the diffusion equation of the frequency-domain electric field and by transforming the space fractional operator into the Laplacian operator; and forming a linear equation system for the electric field by discretizing the spatial fractional electric-field diffusion equation with a meshless method; wherein the linear equation system is formed by: loading a node and searching for nodes in the radius of the support domain, discretizing the fractional definite integral by a 4-point Gaussian integral equation, then interpolating and summing to obtain the fractional derivative of the shape function, assigning the fractional derivative of the shape function to the position of the large sparse matrix in the spatial fractional electric field diffusion equation corresponding to the loaded node; a next node is loaded for the same processing operation, until all nodes are processed to form the linear equation system for all nodes;

5) by means of the computer, solving the linear equation system by a LU decomposition method to obtain an electric field value at each node and obtain the magnetic field value of a corresponding node by a curl equation for the electric field; whereby obtaining the distribution of electric field values and magnetic field values at the frequency; and

6) by means of the computer, obtaining the distribution of electric field values and magnetic field values at different frequencies by changing the frequency of the emitting current and repeating 4) and 5); whereby completing the numerical simulation of the time domain multi-scale induction-polarization symbiosis effects of the electromagnetic field by frequency-time conversion, saving data, plotting and analyzing the data.

Comparing the distribution of electric field values and magnetic field values at different frequencies obtained in 6) of the simulation method with the corresponding distribution of electric field values and magnetic field values obtained by realistic field detection; if they are not consistent with each other, adjusting the parameters for the conductivity model; when they are consistent with each other, the parameters for the conductivity model are optimized for accurately characterizing the conductive characteristics and polarization characteristics of the underground media.

The distribution of electric field values and magnetic field values obtained by realistic field detection is realized by using the transmitter of an electric source electromagnetic transmitting system to emit current; and using a receiving system that comprises a movable vehicle platform and a Superconducting Quantum Interference Devices (SQUID) and a receiver that are disposed on the movable vehicle platform, to detect the electric-field values and magnetic-field values at various detection spots corresponding the various nodes in the simulation method; wherein the movable vehicle platform is used for moving the receiving system to the various detection spots; the SQUID is used for receiving the magnetic field to obtain the magnetic-field values; and the receiver is used to collect and store the detected data and to obtain the electric-field values by using the magnetic-field values.

2) in the simulation method comprises:

introducing a space fractional term into the conductivity model of the two-phase conducting media to establish a multi-scale space-time fractional conductivity model, wherein the time fractional terms characterize the multi-capacitance polarization effect of the media and the space fractional term characterizes the induction effect caused by the complex geometric structure of the media;

4) in the simulation method comprises:

transforming, by fractional operator transformation, the space fractional operator of the conductivity into the Laplacian operator to form a fractional Laplacian operator and obtain the space fractional electric-field diffusion equation;

expanding the fractional Laplacian operator into a fractional differential form, and spatially discretizing the fractional differential by using Caputo fractional derivative;

transforming, by a radial point interpolation meshless method, the second-order partial differential operation of the electric field into the second-order partial differential interpolation of the shape function, to complete the discretization of the differential term in the Caputo fractional order;

transforming, by a Gaussian numerical integration method, the integral operation into Gaussian numerical integration accumulation, to complete the discretization of the integral term in the Caputo fractional order so that the fractional electric-field diffusion equation is transformed into a linear equation system about the electric field.

Specifically, the established multi-scale space-time fractional conductivity model is expressed by:

$$σ ( ω ) = {{σ}_{0} ( i v )}^{α} ( 1 + {f}_{1} {M}_{1} [ 1 - \frac{1}{1 + {( i ω {τ}_{1} )}^{{C}_{1}}} ] + {f}_{2} {M}_{2} [ 1 - \frac{1}{1 + {( i {ωτ}_{2} )}^{{C}_{2}}} ] ) \qquad ( 1 )$$

In (1), σ(ω) is the conductivity in the frequency domain, i is the imaginary part, ω is the angular frequency, σ₀ is the value of the DC conductivity, fₗ (l=1 or 2) is the volume fraction of the type-l particle, Mₗ is the rock material property tensor, τₗ is the time constant of the type-l particle, Cₗ is the dispersion coefficient of the type-l particle, (iv)^{α} operator corresponds to the space fractional derivative for the Fourier mapping, v is the dimensionless geometric factor, and α is the fractal dimension of the anomaly. The parameters in the equation (1) are the parameters for the conductivity model set in 3) of the simulation method and may be optimized as the parameters for the actual underground media to accurately reflect conductive characteristics and polarization characteristics of the actual underground media.

The multi-scale space-time fractional conductivity model expression (1) is substituted into the diffusion equation of the frequency domain electric field of the two-phase conducting media:

$${∇}^{2} E - {{σ}_{0} ( i ν )}^{α} ( 1 + {f}_{1} {M}_{1} [ 1 - \frac{1}{1 + {( i ω {τ}_{1} )}^{{C}_{1}}} ] + {f}_{2} {M}_{2} [ 1 - \frac{1}{1 + {( i ω {τ}_{2} )}^{{C}_{2}}} ] ) ( i ωμ E ) = 0 ; \qquad ( 2 )$$

in the equation (2), ∇² is the Laplacian operator, E is the electric field, and μ is the magnetic permeability which is set in 3) of the simulation method.

Both ends of equation (2) are multiplied by (iv)-^{α} to obtain the spatial fractional electric-field diffusion equation:

$${( {∇}_{v}^{2} )}^{s} E - {σ}_{0} ( 1 + {f}_{1} {M}_{1} [ 1 - \frac{1}{1 + {( i ω {τ}_{1} )}^{{C}_{1}}} ] + {f}_{2} {M}_{2} [ 1 - \frac{1}{1 + {( i ω {τ}_{2} )}^{{C}_{2}}} ] ) ( i ω μ E ) = 0 ; \qquad ( 3 )$$

in the equation (3),

$$s = 1 - \frac{α}{2} , {( {∇}_{v}^{2} )}^{s}$$

is the fractional Laplacian operator in the dimensionless coordinates v; and the three-dimensional expression of the fractional Laplacian operator is:

$${( {∇}_{v}^{2} )}^{s} E = \frac{{\partial }^{2 s} E}{\partial {x}^{2 s}} + \frac{{\partial }^{2 s} E}{\partial {y}^{2 s}} + \frac{{\partial }^{2 s} E}{\partial {z}^{2 s}} \qquad ( 4 )$$

where E represents the electric field, and x, y, and z each represent the deflection of the electric field in a direction.

By the Caputo fractional definition expansion, the space fractional differential term in the equation (4) is discretized and approximated:

$$\frac{{\partial }^{2 s} E}{\partial {u}^{2 s}} = \frac{1}{Γ ( 2 - 2 s )} {\int }_{a}^{u} \frac{{E}^{( 2 )} ( τ )}{{( u - τ )}^{2 s - 1}} d τ + \frac{1}{Γ ( 2 - 2 s )} {\int }_{u}^{b} \frac{{E}^{( 2 )} ( τ )}{{( u - τ )}^{2 s - 1}} d τ \qquad ( 5 )$$

where u=x, y or z, Γ is the gamma function, a is the lower limit of integration in the u direction, b is the upper limit of integration in the u direction, τ is the integral variable.

Transforming, by a radial basis function meshless method, the second-order partial differential operation of the electric field into the second-order partial differential interpolation of a shape function to complete the discretization of the differential term in the Caputo fractional order:

$$\frac{{\partial }^{2 s} E}{\partial {u}^{2 s}} = {\sum }_{i = 1}^{n} [ \frac{1}{Γ ( 2 - 2 s )} {\int }_{a}^{u} \frac{{ϕ}_{ui}^{( 2 )} ( τ )}{{( u - τ )}^{2 s - 1}} d τ + \frac{1}{Γ ( 2 - 2 s )} {\int }_{u}^{b} \frac{{ϕ}_{ui}^{( 2 )} ( τ )}{{( τ - u )}^{2 s - 1}} d τ ] {E}_{i} ; \qquad ( 6 )$$

wherein Γ is the gamma function, Eᵢ is a number of interpolation nodes near E, ϕᵤᵢ is the corresponding interpolation shape function, ϕᵤᵢ⁽²⁾ is the second-order partial derivative of the interpolation shape function with respect to u.

Transforming, by a Gaussian numerical integration method, the integral operation into Gaussian numerical integration accumulation to complete the discretization of the integral term in the Caputo fractional order:

first, transforming an integration interval into unit sub-units by coordinate transformation, wherein, by taking equation (6) as an example, if

$$τ = \frac{u - a}{2} η + \frac{u + a}{2} ,$$

then:

$$\frac{u - a}{{2}^{2 - 2 s}} {\int }_{- 1}^{1} \frac{{ϕ}_{i}^{( 2 )} ( \frac{u - a}{2} η + \frac{u + a}{2} )}{{( u - u η + a η - a )}^{2 s - 1}} d η \qquad ( 7 )$$

second, discretizing the integral term by the Gaussian numerical integration method:

$$\frac{u - a}{{2}^{2 - 2 s}} {\sum }_{k = 1}^{n} {A}_{k} \frac{{ϕ}_{i}^{( 2 )} ( \frac{u - a}{2} {η}_{k} + \frac{u + a}{2} )}{{( u - u {η}_{k} + a {η}_{k} - a )}^{2 s - 1}} \qquad ( 8 )$$

wherein ηₖ is the Gaussian integration point and Aₖ is the weight coefficient.

In 5) of the simulation method, the magnetic field value is obtained through the curl equation for the electric field:

$$∇ \times E = - \frac{\partial B}{\partial t} ; \qquad ( 9 )$$

In the equation (9), ∇ is the Hamilton operator, x represents the multiply operation, E is the electric field, and B is the magnetic field.

The aforesaid method is implemented through a device for geological exploration, the device comprising:

a computer configured to simulate the distribution of electric and magnetic field values in different geological structures, and to set different transmitting parameters and receiving distances, and different nodes and different frequencies; and

a transient electromagnetic (TEM) detection system comprising a transmitting system and a receiving system; the transmitting system being configured, according to different geological structure characteristics and detection targets, to set the transmitting parameters and the receiving distance, based on the transmitting parameters and the receiving distance corresponding to the geological electric field value and magnetic field value under different frequencies simulated by the computer, and to transmit the current according to the transmitting parameters, and the receiving system being configured to synchronously collect the geological signal excited by the transmitting system.

When in use, the transmitting parameters and receiving distance of the TEM detection system are set through:

molding a geological structure, and simulating the distribution of electric and magnetic field values under different transmitting parameters and receiving distance, different nodes and different frequencies; and

according to the characteristics of geological structure and target to be detected, determining the transmitting parameters and receiving distance corresponding to the electric field value and magnetic field value of geology under different frequencies, and setting the transmitting parameters and receiving distance of TEM detection system.

### EXAMPLE

With reference to FIG. 1, a simulation method of two-phase conducting media comprises:

1) setting a square computation area having a rectangular coordinate system (x: −40 km to 40 km, and z: −40 km to 40 km) which corresponds to the actual detected area, in which total 101101=10201 nodes are uniformly distributed with a spacing of 800 m; and applying Dirichlet boundary conditions on four sides of the computation area, with the middle point of an artificial current source arranged at (0 m, 0 m); wherein the artificial current source corresponds to the transmitter of an electric source electromagnetic transmitting system which is a long wire; the middle point of the artificial current source corresponds to the middle point of the long wire;

2) setting initial parameters in the entire computation area: emission frequency of 2n Hz (n=0, 1, 2, . . . , 10), magnetic permeability of 4π*10⁻⁷, ground conductivity of 0.01 S/m, air conductivity of 1*10⁻⁶ S/m, c of 0.5, time constant of 0.01 s, direct current (DC) conductivity of 0.01 S/m frozen soil between 40 m and 120 m, and sending and receiving distance of 20 m; these initial parameters are set based on the existing geological data, and are not necessary the parameters for the actual underground media;

3) setting initial parameters for the meshless method (including the selection of shape function types and the setting of shape function parameters and support domain parameters), initializing the large sparse matrix K (10201×10201 in size), loading a first computation point and searching for nodes in the radius of the support domain, interpolating to obtain a shape function, discretizing the definite integral by a 4-point Gaussian integral equation, then interpolating and summing to obtain the fractional derivative of the shape function, assigning the shape function result to the corresponding position of the large sparse matrix, selecting a next computation point from the nodes until all computation points are processed to form a linear equation system about the nodes, loading Dirichlet boundary conditions and a current source, solving the linear equation system by a LU decomposition method to obtain an electric field value at each node, and by changing the current emission frequency, obtaining the magnetic field values at different frequencies and then obtaining the magnetic field values by the curl equation for the electric field.

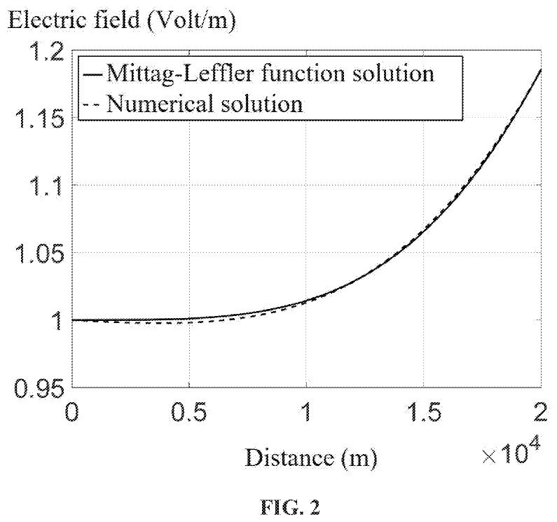

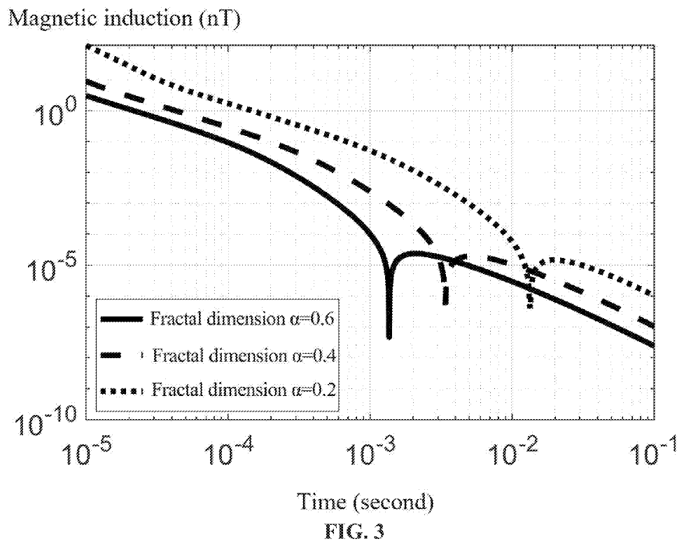

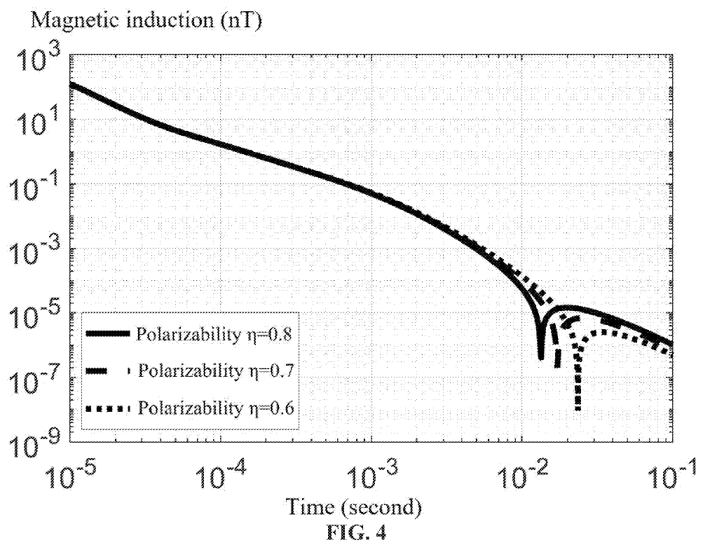

4) completing the numerical simulation of the time domain multi-scale induction-polarization symbiosis effects of the electromagnetic field by frequency-time conversion, saving data, and plotting. As shown in FIG. 2, the numerical solution by the meshless method and the Mittag-Leffler function as the analytical solution are basically consistent. As shown in FIG. 3, the fractal dimension influences the amplitude of the received induced electromotive force and the generation time of the opposite sign. The greater the fractal dimension, the smaller the response amplitude, and the earlier the generation of the opposite sign. As shown in FIG. 4, the polarizability influences the generation time of the opposite sign of the received induced electromotive force. The greater the polarizability, the earlier the generation of the opposite sign.

Comparing the distribution of electric field values and magnetic field values at different frequencies obtained in the simulation method with the corresponding distribution of electric field values and magnetic field values obtained by realistic field detection; if they are not consistent with each other, adjusting the parameters for the conductivity model; when they are consistent with each other, the parameters for the conductivity model are optimized as the parameters of the underground media which accurately characterize the conductive characteristics and polarization characteristics of the underground media.

The distribution of electric field values and magnetic field values obtained by realistic field detection is realized by: using the transmitter of an electric source electromagnetic transmitting system to emit current; and using a receiving system that comprises a movable vehicle platform and a Superconducting Quantum Interference Devices (SQUID) and a receiver that are disposed on the movable vehicle platform, to detect the electric-field values and magnetic-field values at various detection spots corresponding the various nodes in the simulation method; wherein the movable vehicle platform is used for moving the receiving system to the various detection spots; the SQUID is used for receiving the magnetic field to obtain the magnetic-field values; and the receiver is used to collect and store the detected data and to obtain the electric-field values by using the magnetic-field values.

It will be obvious to those skilled in the art that changes and modifications may be made, and therefore, the aim in the appended claims is to cover all such changes and modifications.

What is claimed is:

1. A method of electromagnetic diffusion, comprising:
1) by means of a computer, setting a simulated computation area having a reference coordinate system; setting nodes for obtaining the electric field or magnetic field distribution in the computation area; setting the middle point of an artificial current source at the origin of the reference coordinate system; and applying Dirichlet boundary conditions at the boundary of the computation area;
2) by means of the computer, constructing a multi-scale space-time fractional conductivity model using
$$σ ( ω ) = {{σ}_{0} ( i v )}^{α} ( 1 + {f}_{1} {M}_{1} [ 1 - \frac{1}{1 + {( i {ωτ}_{1} )}^{{C}_{1}}} ] + {f}_{2} {M}_{2} [ 1 - \frac{1}{1 + {( i {ωτ}_{2} )}^{{C}_{2}}} ] ) ; \qquad ( 1 )$$
wherein:
the conductivity model comprises a space fractional term, and a time fractional term for particles of a certain type;
σ(ω) is the conductivity in the frequency domain, i is the imaginary part, ω is the angular frequency, and σ₀ is the value of the DC conductivity;
(iv)^{α} represents the space fractional term, and is a space fractional operator having a fractional order α for the Fourier mapping, α is the fractal dimension of the anomaly, and v is the dimensionless geometric factor;
$$\frac{1}{1 + {( i {ωτ}_{1} )}^{{C}_{1}}}$$
represents the time fractional term for the type-1 particles, τ₁ is the time constant of the type-1 particles, and C₁ is the dispersion coefficient of the type-1 particles;
f₁ is the volume fraction of the type-1 particles, and M₁ is the rock material property tensor of the type-1 particles;
$$\frac{1}{1 + {( i {ωτ}_{2} )}^{{C}_{2}}}$$
represents the space fractional term for the type-2 particles, τ₂ is the time constant of the type-2 particles, and C₂ is the dispersion coefficient of the type-2 particles; and
f₂ is the volume fraction of the type-2 particles, M₂ is the rock material property tensor of the type-2 particles;
3) by means of the computer, setting the current amplitude and the frequency for the emitting current of the current source, parameters for the conductivity model, the ground conductivity, the air conductivity, and the magnetic permeability; selecting a shape function in the computation area by a meshless method, and setting parameters for the shape function, a radius of a support domain, Gaussian integral parameters;
4) by means of the computer, obtaining a spatial fractional electric-field diffusion equation by substituting the expression (1) for the conductivity model into the diffusion equation of the electric field; and processing the spatial fractional electric-field diffusion equation to form a linear equation system for all nodes;
5) by means of the computer, solving the linear equation system to obtain an electric field value at each node and obtain a magnetic field value of a corresponding node by a curl equation for an electric field; whereby obtaining the distribution of electric field values and magnetic field values at the frequency; and
6) by means of the computer, obtaining a distribution of electric field and magnetic field values at different frequencies by changing the frequency of the emitting current and repeating 4) and 5).

2. The method of claim 1, further comprising comparing the distribution of electric field values and magnetic field values at different frequencies obtained in 6) with the corresponding distribution of electric field values and magnetic field values obtained by realistic field detection, so as to optimize the parameters for the conductivity model.

3. The method of claim 1, wherein 4) comprises:
41) transforming, by fractional operator transformation, a space fractional operator in the multi-scale space-time fractional conductivity model into a Laplacian operator of the electric field to obtain a fractional Laplacian operator, to obtain the spatial fractional electric field diffusion equation;
42) expanding, by a Caputo fractional definition, the spatial fractional electric field diffusion equation into a fractional differential form;
43) transforming, by a radial point interpolation meshless method, a second-order partial differential operation of the electric field into a second-order partial differential interpolation of the shape function, to complete a discretization of a differential term in a Caputo fractional order; and
44) transforming, by a Gaussian numerical integration method, an integral operation into Gaussian numerical integration accumulation, to complete a discretization of an integral term in the Caputo fractional order.

4. The method of claim 3, wherein in 41), the expression (1) for the conductivity model is substituted into the diffusion equation of electric field:
$${∇}^{2} E - {{σ}_{0} ( i ν )}^{α} ( 1 + {f}_{1} {M}_{1} [ 1 - \frac{1}{1 + {( i {ωτ}_{1} )}^{{C}_{1}}} ] + {f}_{2} {M}_{2} [ 1 - \frac{1}{1 + {( i {ωτ}_{2} )}^{{C}_{2}}} ] ) ( i ωμ E ) = 0 ; \qquad ( 2 )$$
both ends of equation (2) are multiplied by (iv)-^{α} to obtain the spatial fractional electric-field diffusion equation:
$${( {∇}_{v}^{2} )}^{s} E - {σ}_{0} ( 1 + {f}_{1} {M}_{1} [ 1 - \frac{1}{1 + {( i {ωτ}_{1} )}^{{C}_{1}}} ] + {f}_{2} {M}_{2} [ 1 - \frac{1}{1 + {( i {ωτ}_{2} )}^{{C}_{2}}} ] ) ( i ω μ E ) = 0 ; \qquad ( 3 )$$
wherein
$$s = 1 - \frac{α}{2} , {( {∇}_{v}^{2} )}^{s}$$
is the fractional Laplacian operator in the dimensionless coordinates v; and the three-dimensional expression of the fractional Laplacian operator is:
$${( {∇}_{v}^{2} )}^{s} E = \frac{{\partial }^{2 s} E}{\partial {x}^{2 s}} + \frac{{\partial }^{2 s} E}{\partial {y}^{2 s}} + \frac{{\partial }^{2 s} E}{\partial {z}^{2 s}} \qquad ( 4 )$$
wherein E represents the electric field, and x, y, and z each represent a deflection of the electric field in a direction.

5. The method of claim 4, wherein in 42) by the Caputo fractional definition expansion, the space fractional differential term in equation (4) is discretized and approximated:
$$\frac{{\partial }^{2 s} E}{\partial {u}^{2 s}} = \frac{1}{Γ ( 2 - 2 s )} {\int }_{a}^{u} \frac{{E}^{( 2 )} ( τ )}{{( u - τ )}^{2 s - 1}} d τ + \frac{1}{Γ ( 2 - 2 s )} {\int }_{u}^{b} \frac{{E}^{( 2 )} ( τ )}{{( u - τ )}^{2 s - 1}} d τ \qquad ( 5 )$$
wherein u=x, y or z, Γ is a gamma function, a is a lower limit of integration in a u direction, b is an upper limit of integration in the u direction, and τ is an integral variable.

6. The method of claim 5, wherein in 43), transforming, by a radial basis function meshless method, the second-order partial differential operation of the electric field into the second-order partial differential interpolation of the shape function to complete the discretization of the differential term in the Caputo fractional order in Equation (5):
$$\frac{{\partial }^{2 s} E}{\partial {u}^{2 s}} = {\sum }_{i = 1}^{n} [ \frac{1}{Γ ( 2 - 2 s )} {\int }_{a}^{u} \frac{{ϕ}_{ui}^{( 2 )} ( τ )}{{( u - τ )}^{2 s - 1}} d τ + \frac{1}{Γ ( 2 - 2 s )} {\int }_{u}^{b} \frac{{ϕ}_{ui}^{( 2 )} ( τ )}{{( τ - u )}^{2 s - 1}} d τ ] {E}_{i} \qquad ( 6 )$$
wherein Γ is the gamma function, Eᵢ is a number of interpolation nodes near E, ϕᵤᵢ is a corresponding interpolation shape function, ϕᵤᵢ⁽²⁾ is the second-order partial derivative of the interpolation shape function with respect to u.

7. The method of claim 6, wherein in 44), transforming, by a Gaussian numerical integration method, the integral operation into Gaussian numerical integration accumulation to complete the discretization of the integral term in the Caputo fractional order by:
transforming an integration interval into unit sub-units by coordinate transformation, wherein, if
$$τ = \frac{u - a}{2} η + \frac{u + a}{2} ,$$
then:
$$\frac{u - a}{{2}^{2 - 2 s}} {\int }_{- 1}^{1} \frac{{ϕ}_{l}^{( 2 )} ( \frac{u - a}{2} η + \frac{u + a}{2} )}{{( u - u η + a η - a )}^{2 s - 1}} d η ; \qquad ( 7 )$$
and
discretizing the integral term by the Gaussian numerical integration method:
$$\frac{u - a}{{2}^{2 - 2 s}} {\sum }_{k = 1}^{n} {A}_{k} \frac{{ϕ}_{i}^{( 2 )} , ( \frac{u - a}{2} {η}_{k} + \frac{u + a}{2} )}{{( u - u {η}_{k} + a {η}_{k} - a )}^{2 s - 1}} \qquad ( 8 )$$
wherein ηₖ is a Gaussian integration point and Aₖ is a weight coefficient.
